(19) United States
(12) Patent Application Publication
(10) Pub. No.: US 2020/0260224 A1
(43) Pub. Date: Aug. 13, 2020

(54) NON-TRADITIONAL LOCATION IDENTIFICATION AND SERVICE PROVISION

(71) Applicant: Alex Streltsyn, Staten Island, NY (US)

(72) Inventor: Alex Streltsyn, Staten Island, NY (US)

(21) Appl. No.: 16/785,472

(22) Filed: Feb. 7, 2020

Related U.S. Application Data
(60) Provisional application No. 62/802,714, filed on Feb. 8, 2019.

(51) Int. Cl. H04W 4/029; H04W 4/021; G06Q 30/06; G06Q 30/02; G06Q 20/32; G06Q 50/12

(52) U.S. Cl. CPC H04W 4/029; H04W 4/021; G06Q 30/0635; G06Q 50/12; G06Q 20/3276; G06Q 20/3278; G06Q 30/0282

(57) ABSTRACT

A method of providing services to a location has the steps of positioning identification codes on fixed objects whose location is known, indexing the location with reference to the identification code, grouping one or more locations to create a group of locations, providing a menu of goods and services for the group of locations, connecting a unique universal resource locator (URL) to the identification code, the URL connecting to the menu, a customer scanning an identification code, the identification code retrieving the URL, the customer receiving the URL associated with the menu, the customer selecting a menu item to provide an order, transmitting the order comprising location and menu item to a service provider, and the service provider providing the menu item to the customer.

### CROSS REFERENCE TO RELATED APPLICATIONS

NOT APPLICABLE

### STATEMENT REGARDING FEDERALLY SPONSORED RESEARCH OR DEVELOPMENT

NOT APPLICABLE

### FIELD OF THE INVENTION

The present invention relates to a method for managing the flow of sales and service inquiries in non-traditional geographic spaces.

### BACKGROUND OF THE INVENTION

It is important to know the location of people to provide them with goods and services when they are in non-traditional locations (like their homes or offices) that have addresses or other indexing to allow them to be easily found. However, when customers are seated in a restaurant, in a hotel room or at a resort swimming pool, their precise location is not easily ascertainable. GPS, which operates with mobile phones that are carried by most people, is currently not precise enough to pinpoint the location of persons for the electronic ordering of services. For these types of locations, an indexing means is used by servers who know the area, like numbering the tables on a chart or diagram, which they periodically survey to take orders or deliver food and drinks.

It is a required to deploy a system that indexes physical non-traditional places within a property, such that these places may serve as markers for location, for delivery of goods or services. Therefore, there is a need in the art for a system to be able to pinpoint individuals or parties at certain locations so that goods or services may be provided to them.

### SUMMARY OF THE INVENTION

From the foregoing, it is seen that it is a problem in the art to provide a device and method meeting the above requirements. According to the present invention, a device and method is provided which meets the aforementioned requirements and needs, expeditiously and at a low cost. Specifically, the device and method according to the present invention provides a method and an application for mobile devices for implementing a method for managing the flow of sales and service inquiries, especially those generated by customers in non-standard, non-addressed spaces.

The device and method of the present invention provides an app and a method for, but not limited to, clients to order services, view a menu, order menu items, request assistance, rent or borrow articles, order goods, or request information. The method provides a system supporting business-to-client as well as business-to-business interactions. Other objects and advantages of the present invention will be more readily apparent from the following detailed description when read in conjunction with the accompanying drawings.

A method of providing services to a location has the steps of positioning identification codes on fixed objects whose location is known, indexing the location with reference to the identification code, grouping one or more locations to create a group of locations, providing a menu of goods and services for the group of locations, connecting a unique universal resource locator (URL) to the identification code, the URL connecting to the menu, a customer scanning an identification code, the identification code retrieving the URL, the customer receiving the URL associated with the menu, the customer selecting a menu item to provide an order, transmitting the order comprising location and menu item to a service provider, and the service provider providing the menu item to the customer.

In an embodiment, the identification code is selected from the group consisting of QR codes and RFID codes. In another embodiment, the service provider is a restaurant or bar. In an embodiment, neither the order nor the customer location is encrypted. The order and identification code may be encrypted using a 64-bit or higher encryption VPN tunnel in order to maintain security of the customer details. Further, a hash may be used to authenticate the source of the order as the customer.

In an embodiment, there is a further step of the service provider closing the order, and/or the step of the customer providing feedback and closing the order. The service may be provided by a human, such as a waiter, or by network, like an application or electronic map, or by drone or delivery robot, and in an embodiment a single identification code may be associated with a plurality of businesses;

A method of ordering a service has the steps of seeing an identification code, scanning the identification code with an app on a mobile device, the app identifying a unique location associated with the identification code, receiving a menu of goods and services that may be ordered from the location, from a business available to serve that location, choosing one or more goods and services to order, and an order arriving at the location identified by the identification code.

An embodiment has the additional step of providing feedback on the order through the application, and in some cases a plurality of businesses are available to serve a single location.

### BRIEF DESCRIPTION OF THE DRAWINGS

FIG. 1 is a overview of a method for managing the flow of sales and service inquiries, from non-traditional locations.

FIG. 2 is a flowchart showing the back-end merchant use of the system.

FIG. 3 is a flowchart showing the customer/user interaction with the system.

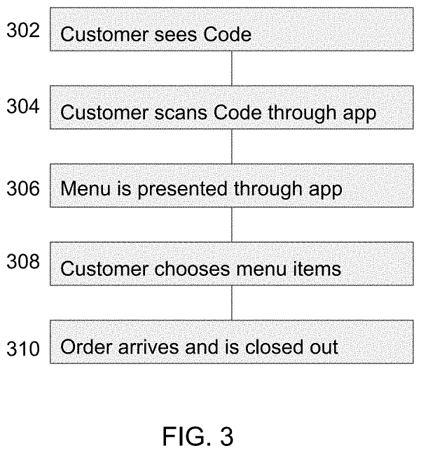

### DETAILED DESCRIPTION OF THE INVENTION

The method of the present invention provides a flow of business that connects customers in non-standard locations with services, and food and drink, using a mobile device.

Generally speaking, the user begins the process by scanning a QR code or an RFID tag (or other feature to provide a unique identification number to a code or tag scannable by a mobile phone) near his or her location into a mobile device. Said QR code is tagged to a location and generally conspicuously placed on the location (e.g. a chair, table, door, umbrella, golf flag, etc.). Said location is assigned to a property in the management portal of the platform.

The software checks to see if the user's mobile device is within a custom range of the property, to ensure that the order is being made by a person on the property of the business. The property's GPS coordinates are sent to the system, and if the user is within an allowed range, the user lands on the platform page wherein the user may purchase goods and services from one or more designated service provider businesses connected with that property.

Example Actions:
invoke a service request (can be immediate without additional clicks)
view options/menus/information
order goods and/or services
accept payments
integrate with local POS or app

Service requests may involve massage or entertainment, for example. Menus may result in service of food, drink or tobacco. Information may be available like a concierge service. Payments may also be accepted or integration with POS systems.

Service providers, also known as responders, and their staff receive request alerts with details about the action and location of the request on a screen. The responder responds in accordance with the request and closes the request on their screen, ending the process. The customer closes the order and also optionally provides feedback.

Alternatively, instead of scanning a QR Code affixed to an object with a known location, the user opens an application (mobile or web based) and their mobile device sends its GPS coordinates to the system. The responder is alerted and processes the request. Alternatively, the QR code can be replaced with location tagging such as numeric or alphabetic or alphanumeric tags, or bar codes—any system known in the art for uniquely encoding of data, including identification and location data comprising a description understandable to the staff of the business, optionally along with GPS location of the location, especially in a larger property like a golf course. The user opens an application (mobile or web based) and types or scans the identification tag. The identification of the location can be found anywhere the tag is placed. The responder is alerted and processes the request. In an alternative embodiment an RFID chip enabling Near Field scanning is used, such that when the mobile device is brought close to the RFID point, with an open application, the mobile device receives the unique location and identification information provided by the RFID chip.

Alternatively, the property management/responders can provide the vicinity of the property and let the user manually move a pin to indicate their location on the map within the application. The responder is alerted and processes the request, and is able to deliver the products or services.

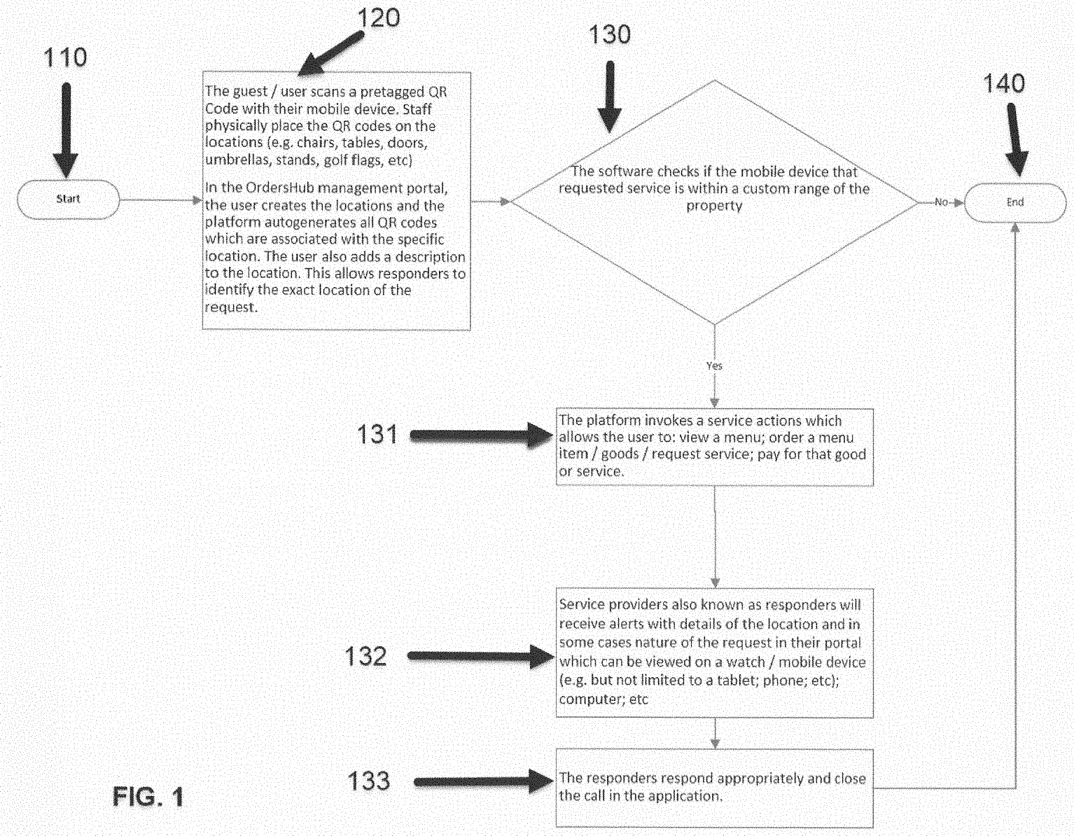

With reference to FIG. 1, an overview of the system is shown, wherein the method of the present invention includes a starting point 110, a tagging process 120, a range criterion 130 with steps for granting user access 131 to a portal; assignment 132 of service provider to client; and close 133 of call, as well as an end point 140.

### Merchant Side

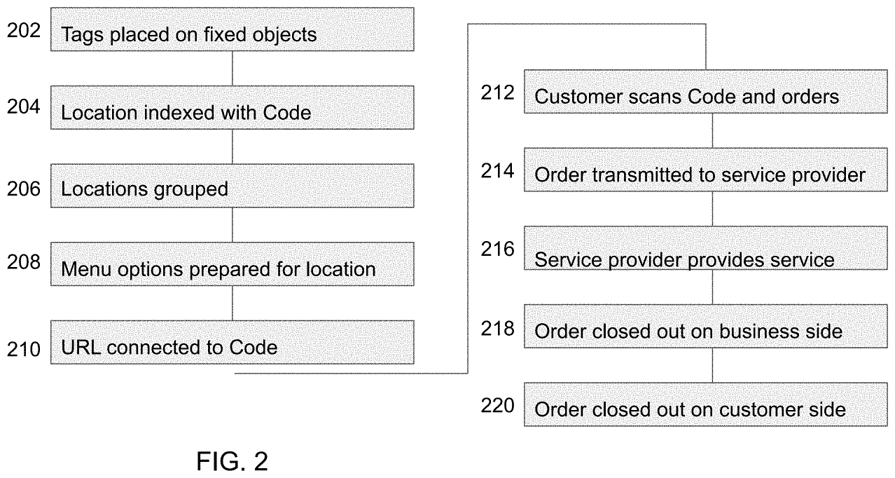

With reference to FIG. 2, when the merchant or service provider is setting up the system, the QR codes (or other unique identification tags like RFID tags) are placed on fixed objects whose location the business knows in step 202, and the location is indexed in the system with reference to the QR code identification in step 204. In step 206 the locations are grouped, and in step 208 a menu of goods and services is prepared for a particular group of locations. In step 210, a unique universal resource locator (URL) is connected to the QR code or RFID tag, to provide a unique identifier through the Internet and software. The URL is triggered by the QR code, and contains location and menu associated with particular business. A single QR code may be associated with multiple businesses.

In step 212, the customer at the location identified through a QR code orders particular goods or services, and these goods and services are entered into a database and in step 214 are transmitted to a service that provides such as a restaurant or entertainment within a resort. The transmission is end-to-end encrypted using a 64-bit or higher encryption VPN tunnel in order to maintain security of the customer details. In step 216, the service provider carries out the service, whether by a human service provider or a drone or robot carrying food or drink, for example, to the indicated location. In step 218 the service is carried out and closed out. In step 220 the person receiving the service optionally provides feedback and closes the order.

### Customer Side

In step 302 the customer sees a QR code or other location-identification point containing an RFID chip, for example, to interface with an app and identify a unique location within a business. Once the customer has started the app and uniquely identified the location in step 304, in step 306 the user receives a menu of goods and services that may be ordered from the location, from any number of businesses that are available to serve that location. In step 308 the customer chooses one or more goods and services to order, and in step 310 the order arrives to the location identified by the QR code or RFID tag. The consumer optionally provides feedback on the order through the application.

In order to verify the authenticity of an order, the system selectively verifies the location of person ordering, so that false orders are not entered into the system. In an embodiment, there is a geo-fence or proximity limit for the customer's location as determined from their mobile device, or the system may verify that the mobile device is connected to the WIFI of the property or can see the WIFI of the property.

In another embodiment, Wi-Fi positioning system (WPS), WIPS or WFPS is a geolocation system that uses the characteristics of nearby Wi-Fi hotspots and other wireless access points to determine whether the user is on or near the property. In some cases this is used where satellite navigation such as GPS is inadequate due to various causes including multipath and signal blockage indoors, or where acquiring a satellite fix would take too long. In an embodiment this verification include assisted GPS, urban positioning services through hotspot databases, and indoor positioning systems. The preferred technique used for positioning with wireless access points is based on measuring the intensity of the received signal (received signal strength indication or RSSI) and the method of “fingerprinting”. Typical parameters useful to geolocate the wireless access point include its SSID and MAC address. The accuracy depends on the number of nearby access points whose positions have been entered into the database. The Wi-Fi hotspot database gets filled by correlating mobile device GPS location data with Wi-Fi hotspot MAC addresses. The possible signal fluctuations that may occur can increase errors and inaccuracies in the path of the user, but certain techniques can be applied to filter the noise.

In another embodiment, the menu system is preferentially ordered according to previous orders from the unique customer (identified by the mobile device that is scanning the code) at a known location (according to the code that is scanned), with the more frequently chosen options, first, or options more profitable to the business being shown, or accompaniments to known earlier orders. In an embodiment, the ordering of the menu items is arranged by artificial intelligence.

Other applications for technology without limitation, may be the service of mechanical features and fixtures in buildings. For example, the mechanical fixtures such as lights, vents, plumbing fixtures, may all be identified by QR codes or RFID. Once scanned by a tenant who notices a malfunction, the fixture is automatically reported as faulty and requiring attention, and same transmitted to the maintenance staff, or a menu is presented of optional reporting on the fixture. The technology may also be used in property management, for example once a property is cleaned the cleaners will scan the QR code or RFID tag, and a condition statement is automatically updated to clean for that property. In another embodiment a menu may be used to identify deficiency items to be dealt with by a handyman. In the case of property management, the system may be seamlessly integrated with the property management system to create problem tickets on reporting by tenants or customers.

The following statement summarizes an important novel aspect of the invention, which is believed not suggested in the prior art: A business method for managing the flow of sales and service inquiries in non-traditional locations, specifically via mobile devices.

### CONCLUSION

A business method of the present invention allows an operator to manage inquiries from clients in non-traditional, non-indexed locations, using mobile devices. Utilizing location tagging and GPS, an operator can onboard a select clientele, offer a package of menu and service options, and alert service providers to new inquiries.

The invention being thus described, it will be evident that the same may be varied in many ways by any person having skill in the applicable arts. Such variations are not to be regarded as a departure from the spirit and scope of the invention and all such modifications are intended to be included within the scope of the claims.

1. A method of providing services to a location, comprising the steps of:
a. Positioning identification codes on fixed objects whose location is known;
b. Indexing the location with reference to the identification code;
c. Grouping one or more locations to create a group of locations;
d. Providing a menu of goods and services for the group of locations;
e. Connecting a unique universal resource locator (URL) to the identification code, the URL connecting to the menu;
f. A customer scanning an identification code, the identification code retrieving the URL;
g. The customer receiving the URL associated with the menu;
h. The customer selecting a menu item to provide an order;
i. Transmitting the order comprising location and menu item to a service provider; and
j. The service provider providing the menu item to the customer.

2. The method of claim 1 wherein the identification code is selected from the group consisting of QR codes and RFID codes.

3. The method of claim 1 wherein the service provider is a restaurant or bar.

4. The method of claim 1 wherein transmitting the order is encrypted using a 64-bit or higher encryption VPN tunnel in order to maintain security of the customer details.

5. The method of claim 1 further comprising the step of the service provider closing the order.

6. The method of claim 1 further comprising the step of the customer providing feedback and closing the order.

7. The method of claim 1 wherein the service is provided by drone.

8. The method of claim 1 wherein a single identification code may be associated with a plurality of businesses.

9. A method of ordering a service, comprising the steps of:
a. Seeing an identification code;
b. Scanning the identification code with an app on a mobile device;
c. The app identifying a unique location associated with the identification code;
d. Receiving a menu of goods and services that may be ordered from the location, from a business available to serve that location;
e. choosing one or more goods and services to order;
f. an order arriving at the location identified by the identification code.

10. The method of claim 9 further comprising the step of providing feedback on the order through the application.

11. The method of claim 9 wherein a plurality of businesses are available to serve that location.
